(19) United States
(12) Patent Application Publication
(10) Pub. No.: US 2025/0277404 A1
(43) Pub. Date: Sep. 4, 2025

(54) Pet Door Insert for a French Door

(71) Applicant: Christopher Keeme, Apache Junction, AZ (US)

(72) Inventor: Christopher Keeme, Apache Junction, AZ (US)

(21) Appl. No.: 19/069,881

(22) Filed: Mar. 4, 2025

Related U.S. Application Data
(60) Provisional application No. 63/560,842, filed on Mar. 4, 2024.

(51) Int. Cl. E06B 7/32; A01K 1/035

(52) U.S. Cl. CPC E06B 7/32; A01K 1/035

(57) ABSTRACT

A panel insert for modifying a French door to make the French door pet accessible. The panel insert is positioned and secured within a frame of one of the French door panels. An upper opening and a lower opening are cut or formed into a body of the panel insert. A window component is secured within the upper opening and a pet door component is secured within the lower opening. The pet door component is configured to allow an animal to travel through the French door without human intervention. A pet accessible French door with an integrated panel insert is also provided.

### CROSS-REFERENCE TO RELATED APPLICATION

The present application claims priority to, and the benefit of, U.S. Provisional Application No. 63/560,842, which was filed on Mar. 4, 2024, and is incorporated herein by reference in its entirety.

### FIELD OF THE INVENTION

The present invention generally relates to a pet door. More specifically, the present invention relates to an apparatus for retrofitting a French door that is configured to enable an animal to enter and exit through the French door without human intervention. Accordingly, the present specification makes specific reference thereto. However, it is to be appreciated that aspects of the present invention are also equally amenable to other like applications, devices and methods of manufacture.

### BACKGROUND

Many homes have dog or pet doors that allow domesticated pets to come and go as they please. However, a good number of homes have French doors, which do not currently accommodate a dog door. In these cases, pet owners have to leave the doors open so that their dog can enter and exit. This is not practical for many reasons. Leaving a dog outside in different weather conditions can be detrimental to the animal. Indoor accidents may occur more frequently if the dog cannot get outside to relieve themselves.

A pet door or pet flap is a small opening cut or formed into an exterior door designed to allow pets to enter and exit a building on their own without needing a human to open the door for the animal. Originally created as simple holes, the modern pet door is a typically a panel or flap that the pet can simply push through. These devices offer a degree of protection against wind, rain, and larger-bodied intruders entering the dwelling. Similar hatches can let dogs through fences or other solid barriers.

French doors are a type of door that originated in France and are known for their distinctive design, which features glass panels that extend for most of the door's length and are often divided by a grid. French doors are usually installed as a pair of hinged doors that open from the center, either swinging or sliding. Traditional French doors are wood framed, but can also be vinyl, aluminum, or fiberglass in construction as well. These doors are typically constructed as a pair of doors that open from the center, enhancing natural light and visual connectivity between spaces. Because of the significant glass surface area, French doors are unable to accommodate existing pet doors.

Therefore, there exists a long-felt need in the art for a pet or dog door that can retrofit an existing French door. There is also a long-felt need in the art for a way for owners of existing homes with French doors to accommodate their pets' needs. Further, there is a long-felt need in the art for a way for pets to reenter the home when needed to escape extreme weather conditions. Finally, there is a long-felt need in the art for an alternative for the need for pet owners to leave their exterior door open to accommodate their pet.

In this manner, the improved pet door insert of the present invention accomplishes all of the foregoing objectives, thereby providing an easy solution for ensuring that homes with French doors are able to accommodate their pets' needs by creating a safe and convenient pet door. A primary feature of the present invention is an insert for a French door that creates a pet door to enable animals to exit. Advantageously, the French door insert allows pets to exit through the French door to relieve themselves outside and to reenter the home as desired without human intervention. Finally, the improved French door insert of the present invention is capable of eliminating the need for pet owners to leave their exterior door open to accommodate their dog.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a panel insert for a French door. The French door comprises a first door panel and a second door panel. The first and second door panels each comprise a top rail, a bottom rail, a hinge style, and a lock style. The top and bottom rails and the hinge and lock styles form a frame for a glass portion of each door panel.

The panel insert of the present invention comprises a body comprising a perimeter and a lower opening. The body is sized to fit within an opening in one of the door panels of the French door created by removing the respective glass portion between the top and bottom rails and the hinge and lock styles of the respective door panel. The body may further comprise a transition element surrounding the perimeter of the body. The body may also further comprise an upper opening.

The panel insert may further comprise a window component. The window component is configured to fit within the upper opening of the body. The window component may be fixed or movable within the upper opening. The window component may comprise a frame and a window. The window component may further comprise a window locking element for securing the window. The window component may further comprise a screen. The window component may further comprise a window cover. The window cover is configured to completely cover the upper opening.

The panel insert may further comprise a pet door component. The pet door component is configured to fit within the lower opening of the body. The pet door component comprises a movable portion pivotally mounted within the lower opening. The movable portion is configured to swing both inward and outward. The pet door component further comprises a movable portion locking element for securing the movable portion. The pet door component may further comprise a pet door cover. The pet door cover is configured to completely cover and secure the lower opening.

The subject matter disclosed and claimed herein, in another embodiment thereof, comprises a pet accessible French door. The pet accessible French door comprises a first door panel and a second door panel. The first and second door panels each comprise a top rail, a bottom rail, a hinge style, and a lock style. The top and bottom rails and the hinge and lock styles form a frame for a glass portion of each door panel.

The pet accessible French door further comprises a panel insert. The panel insert comprises a body comprising a perimeter and a lower opening. The body is sized to fit within an opening in one of the first or second door panels created by removing the respective glass portion between the top and bottom rails and the hinge and lock styles of the respective door panel. The body may further comprise a transition element surrounding the perimeter of the body. The body may further comprise an upper opening.

The panel insert may further comprise a window component. The window component is configured to fit within the upper opening of the body. The window component may be fixed or movable within the upper opening. The window component may comprise a frame and a window. The window component may further comprise a window locking element for securing the window. The window component may further comprise a screen. The window component may further comprise a window cover. The window cover is configured to completely cover the upper opening.

The panel insert may further comprise a pet door component. The pet door component is configured to fit within the lower opening of the body. The pet door component comprises a movable portion pivotally mounted within the lower opening. The movable portion is configured to swing both inward and outward. The pet door component further comprises a movable portion locking element for securing the movable portion. The pet door component may further comprise a pet door cover. The pet door cover is configured to completely cover and secure the lower opening.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of a French door for use with a panel insert of one embodiment of the present invention in accordance with the disclosed architecture.

FIG. 2 illustrates a front view of one embodiment of a panel insert of the present invention for use with a French door in accordance with the disclosed architecture.

FIG. 3 illustrates a front view of the panel insert of the present invention for use with the French door in accordance with the disclosed architecture.

FIG. 4 illustrates a front view of a window component of the panel insert of the present invention for use with the French door in accordance with the disclosed architecture.

FIG. 5 illustrates a side view of the window component of the panel insert of the present invention for use with the French door in accordance with the disclosed architecture.

FIG. 6 illustrates a perspective view of a pet door component of the panel insert of the present invention for use with the French door in accordance with the disclosed architecture.

FIG. 7 illustrates a perspective view of the pet door component of the panel insert of the present invention for use with the French door in accordance with the disclosed architecture.

FIG. 8 illustrates a front view of the pet door component of the panel insert of the present invention for use with the French door in accordance with the disclosed architecture.

FIG. 9 illustrates a perspective view of one embodiment of a pet accessible French door of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a specially designed pet door insert for use with French doors that enables a dog to enter and exit the home while keeping the door closed. The invention is comprised of an insert that goes in a French door to replace the glass portion of the door. In one embodiment, the insert may measure approximately 20″×64″×¾″. The insert may be constructed from plywood with no knots. The insert may comprise an opening cut out for a top glass portion of the door, which may be approximately 18″×36″. An optional window may be added that measures approximately 17.5″×35.5″. The insert also includes a flap that enables the animal to enter and exit with case. A door is included to cover the flap when needed.

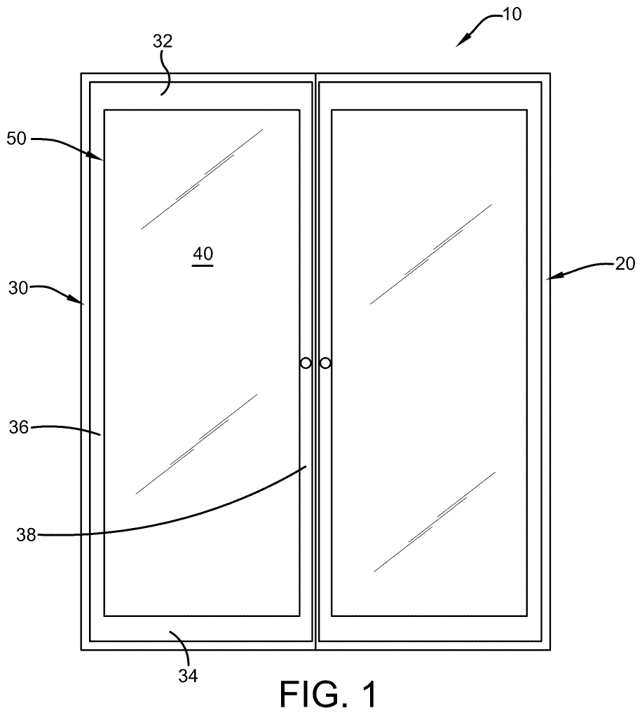

Referring initially to the drawings, FIGS. 1-8 illustrates a panel insert 100 for use with a French door 10 to make the French door 10 pet accessible. As illustrated in FIG. 1, the French door 10 comprises a first door panel 20 and a second door panel 30. The first and second door panels 20 and 30 each comprise a top rail 32, a bottom rail 34, a hinge style 36, and a lock style 38. The top and bottom rails 32 and 34 and the hinge and lock styles 36 and 38 form a frame or an opening 50 for a glass portion 40 of each door panel 20 and 30. The French door 10 may be of any French door configuration that has a pair of hinged doors that open from the center, either swinging or sliding.

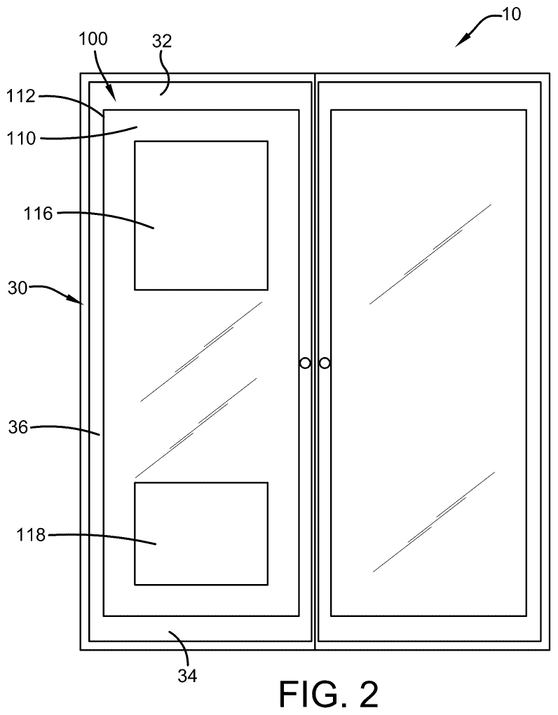

As illustrated in FIG. 2, the panel insert 100 comprises a body 110. The body is typically constructed from wood but may be constructed from any material used in the art of door or window construction. The body 110 is typically rectangular and comprises a perimeter 112 and a lower opening 118. The body 110 is sized to fit within the opening 50 in one of the door panels 20 or 30 of the French door 10 that created by removing the respective glass portion 40 between the top and bottom rails 32 and 34 and the hinge and lock styles 36 and 38 of the respective door panel 20 or 30. The lower opening 118 is positioned in a portion of a lower half of the body 118 and is dimensioned as discussed infra.

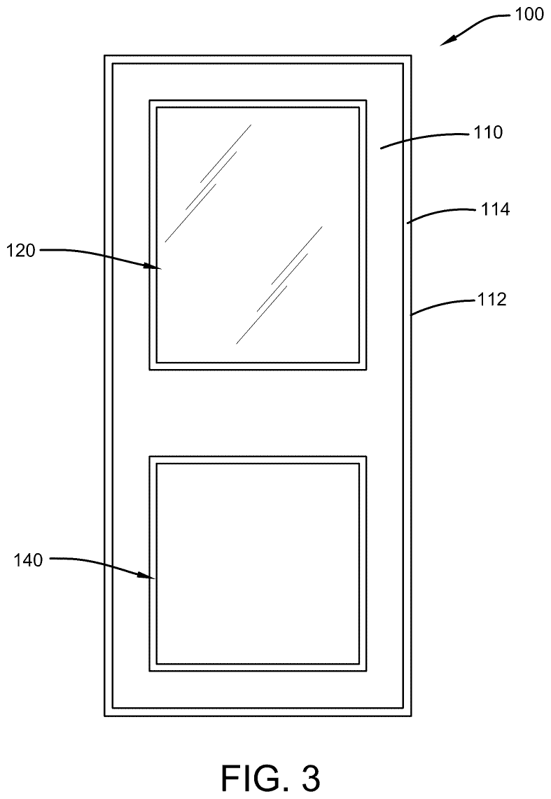

As illustrated in FIG. 3, the body 110 may further comprise a transition element 114. The transition element 114 surrounds the perimeter 112 of the body 110. The transition element 114 may be a metal, rubber, plastic, or foam weatherstripping and may also be designed to adjustably seal or attach the body 110 within the opening 50 of the respective door panel 20 or 30. The body 110 may also further comprise an upper opening 116. The upper opening 116 is positioned in a portion of an upper half of the body 118 and is dimensioned as discussed infra.

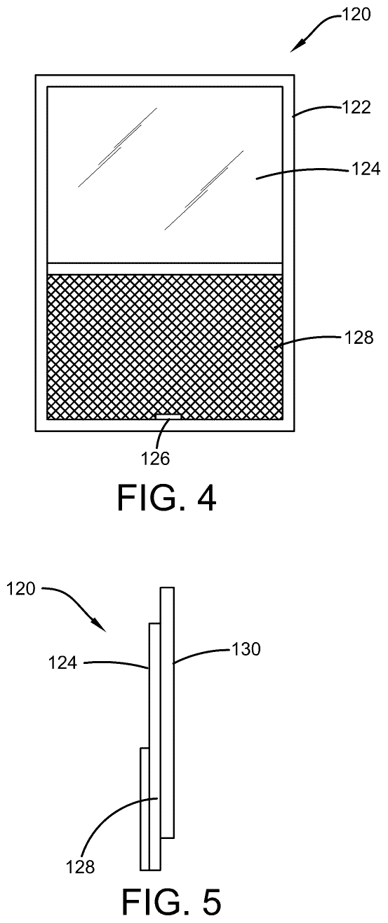

As illustrated in FIGS. 4 and 5, the panel insert 100 may further comprise a window component 120. The window component 120 is dimensioned to fit within the upper opening 116 in the body 110 and may be any size as desired. The window component 120 comprises a window 124. The window 124 may comprise a window frame 122 for securing the window 124 within the upper opening 116. The window 122 may be unopenable, such as a glass panel directly integrated into the body 110 within the upper opening 116, or at least partially openable. The window 122 may be any type, size, shape, and configuration of window such as but not limited to a casement window, an awning window, a slider window, a single hung window, a double hung window, a bay window, a bow window, a garden window, a picture window, a transom window, a stationary window, a hopper window, a jalousie window, a tilt and turn window, a pivot window, an arched window, etc.

The window component 120 may further comprise a window lock 126. The window lock 126 is typically a latch, clasp, magnetic lock, or similar window locking element designed to lock the window 122 when closed. The window component 120 may further comprise a screen 128. The screen 128 may be used alone within the upper opening 116, or in conjunction with the window 122. The window component 120 may further comprise a window cover 130. The window cover 130 is a panel designed to close over, or slide in place behind, the window 122 on an inside side of the French door 10. The window cover 130 is configured to further secure and block access through the upper opening 116.

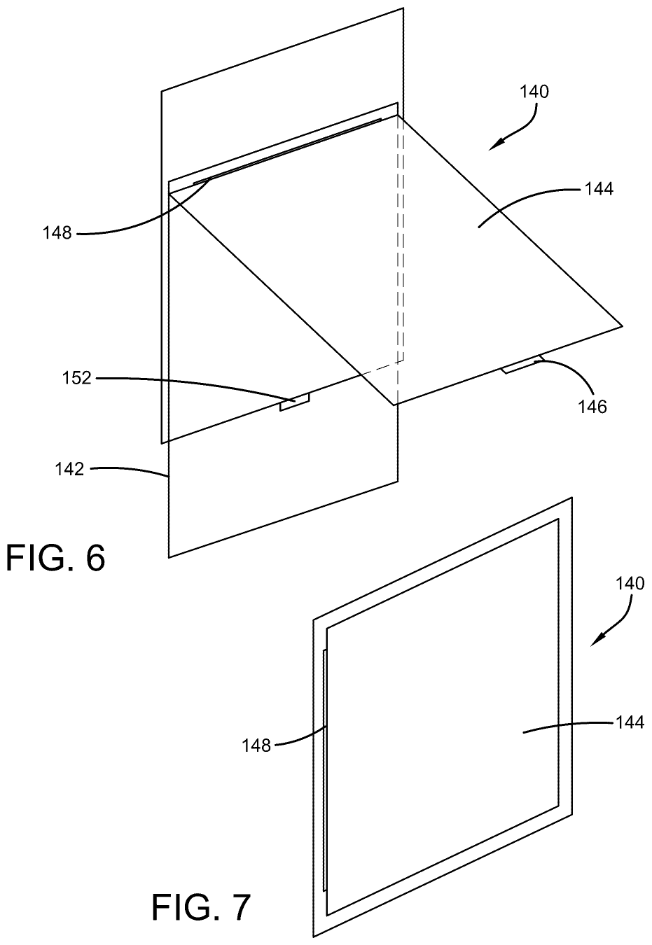

As illustrated in FIGS. 6-8, the panel insert 100 further comprises a pet door component 140. The pet door component 140 is dimensioned to fit within the lower opening 118 in the body 110 and may be any size as desired. The pet door component 140 comprises a movable portion 144. The movable portion 144 is pivotally mounted within the lower opening 118 and configured to swing inward and outward. The pet door component 140 may further comprise a pet door frame 142 for securing the movable portion 144 within the lower opening 118.

The pet door component 140 may be any size, shape, and configuration of a pet door, such as, but not limited to, a manual flap door, a magnetic door, a microchip door, an infrared door, a sliding glass insert door, an electronic door, a screen door, a telescoping door, etc. In one embodiment, the movable portion 144 is a flap. The flap 144 ensures air cannot travel through the lower opening 118 of the body 110. In one embodiment, the flap 144 may be configured to magnetic magnetically engage the lower opening 118.

The pet door component 140 may further comprise a hinge 148. The hinge 148 pivotally mounts the movable portion or flap 144 to the body 110 within the lower opening 118 and permits passage of an animal in both directions as the flap 144 can swing inward and outward. The hinge 148 may be a top mount hinge securing the movable portion 144 from the top, or a side mounted hinge securing the movable portion 144 from the side as illustrated in FIG. 7.

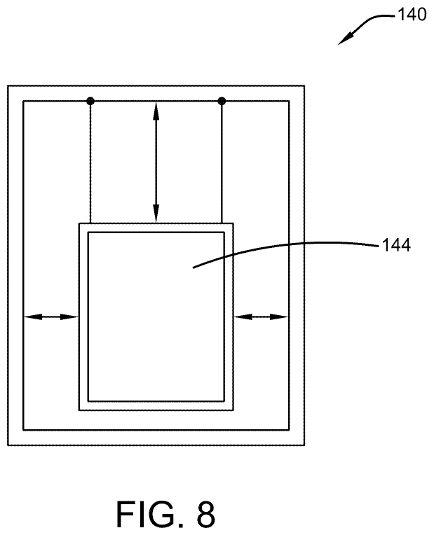

The pet door component 140 may further comprise a pet door lock 146. The pet door lock 146 is typically a latch, clasp, or similar locking element designed to lock the movable portion 144 when closed. The pet door component 140 may further comprise a pet door cover 150. The pet door cover 150 is a panel designed to close over, or slide in place behind the movable portion 144 on an inside side of the French door 10. The pet door cover 150 is configured to further secure and block access through the lower opening 118 and may further be securable with a cover locking element 152. As illustrated in FIG. 8, the movable portion 144 may be adjusted in size within the lower opening 118 to accommodate different sized pets.

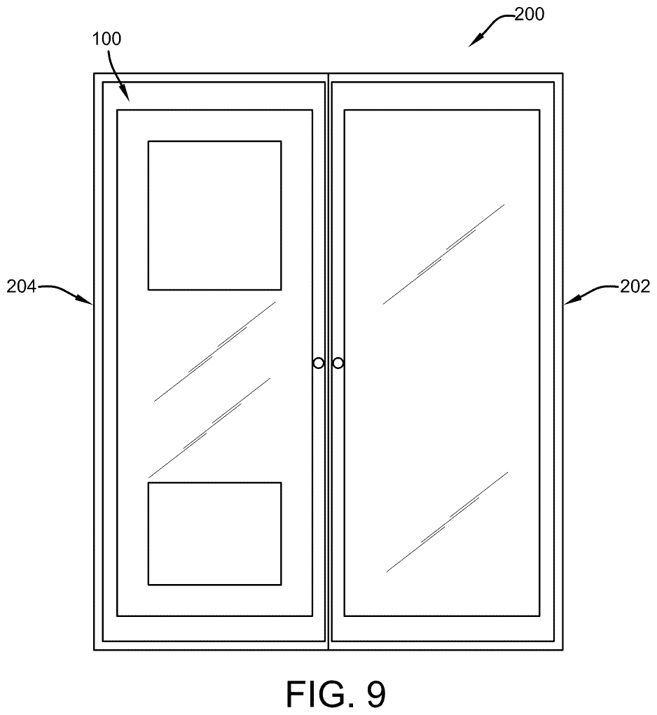

In an additional embodiment, FIG. 9 illustrates a pet accessible French door 200. The pet accessible French door 200 comprises a first door panel 202, a second door panel 204, and a panel insert 100. The first and second door panels 202 and 204 each comprise a top rail 32, a bottom rail 34, a hinge style 36, and a lock style 38. The top and bottom rails 32 and 34 and the hinge and lock styles 36 and 38 form a frame or an opening 50 for a glass portion 40 of each door panel 202 and 204.

The panel insert 100 comprises a body 110. The body is typically constructed from wood, but may be constructed from any material used in the art of door or window construction. The body 110 is typically rectangular and comprises a perimeter 112 and a lower opening 118. The body 110 is sized to fit within the opening 50 in one of the door panels 202 or 204 of the pet accessible French door 200 that created by removing the respective glass portion 40 between the top and bottom rails 32 and 34 and the hinge and lock styles 36 and 38 of the respective door panel 20 or 30. The lower opening 118 is positioned in a portion of a lower half of the body 118 and is dimensioned as discussed infra.

The body 110 may further comprise a transition element 114. The transition element 114 surrounds the perimeter 112 of the body 110. The transition element 114 may be a metal, rubber, plastic, or foam weatherstripping and may also be designed to adjustably seal or attach the body 110 within the opening 50 of the respective door panel 20 or 30. The body 110 may also further comprise an upper opening 116. The upper opening 116 is positioned in a portion of an upper half of the body 118 and is dimensioned as discussed infra.

The panel insert 100 may further comprise a window component 120. The window component 120 is dimensioned to fit within the upper opening 116 in the body 110 and may be any size as desired. The window component 120 comprises a window 124. The window 124 may comprise a window frame 122 for securing the window 124 within the upper opening 116. The window 122 may be unopenable, such as a glass panel directly integrated into the body 110 within the upper opening 116, or at least partially openable. The window 122 may be any type, size, shape, and configuration of window such as but not limited to a casement window, an awning window, a slider window, a single hung window, a double hung window, a bay window, a bow window, a garden window, a picture window, a transom window, a stationary window, a hopper window, a jalousie window, a tilt and turn window, a pivot window, an arched window, etc.

The window component 120 may further comprise a window lock 126. The window lock 126 is typically a latch, clasp, or similar window locking element designed to lock the window 122 when closed. The window component 120 may further comprise a screen 128. The screen 128 may be used alone within the upper opening 116, or in conjunction with the window 122. The window component 120 may further comprise a window cover 130. The window cover 130 is a panel designed to close over, or slide in place behind the window 122 on an inside side of the pet accessible French door 200. The window cover 130 is configured to further secure and block access through the upper opening 116.

The panel insert 100 further comprises a pet door component 140. The pet door component 140 is dimensioned to fit within the lower opening 118 in the body 110 and may be any size as desired. The pet door component 140 comprises a movable portion 144. The movable portion 144 is pivotally mounted within the lower opening 118 and configured to swing inward and outward. The pet door component 140 may further comprise a pet door frame 142 for securing the movable portion 144 within the lower opening 118.

The pet door component 140 may be any size, shape, and configuration of a pet door, such as, but not limited to, a manual flap door, a magnetic door, a microchip door, an infrared door, a sliding glass insert door, an electronic door, a screen door, a telescoping door, etc. In one embodiment, the movable portion 144 is a flap. The flap 144 ensures air cannot travel through the lower opening 118 of the body 110. In one embodiment, the flap 144 may be configured to magnetic magnetically engage the lower opening 118.

The pet door component 140 may further comprise a hinge 148. The hinge 148 pivotally mounts the movable portion or flap 144 to the body 110 within the lower opening 118 and permits passage of an animal in both directions as the flap 144 can swing inward and outward. The hinge 148 may be a top mount hinge securing the movable portion 144 from the top, or a side mounted hinge securing the movable portion 144 from the side.

The pet door component 140 may further comprise a pet door lock 146. The pet door lock 146 is typically a latch, clasp, or similar locking element designed to lock the movable portion 144 when closed. The pet door component 140 may further comprise a pet door cover 150. The pet door cover 150 is a panel designed to close over, or slide in place behind the movable portion 144 on an inside side of the pat accessible French door 200. The pet door cover 150 is configured to further secure and block access through the lower opening 118 and may further be securable with a cover locking element 152.

It is contemplated that the panel insert 100 and pet accessible French door 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

Notwithstanding the foregoing, the panel insert 100 and pet accessible French door 200 of the present invention and its various structural components can be of any suitable size, shape, and configuration as is known in the art without affecting the overall concept of the invention, provided that it accomplishes the above stated objectives. One of ordinary skill in the art will appreciate that the shape and size of the panel insert 100 and pet accessible French door 200 and its various components and material, as shown in the FIGS. are for illustrative purposes only, and that many other shapes and sizes of the panel insert 100 and pet accessible French door 200 are well within the scope of the present disclosure. Although the dimensions of the panel insert 100 and pet accessible French door 200 are important design parameters, the panel insert 100 and pet accessible French door 200 and its components may be of any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A panel insert for a French door, the panel insert comprising:
a body comprising a perimeter and a lower opening; and
a pet door component configured to fit within the lower opening; and
wherein the pet door component comprises a movable portion pivotally mounted within the lower opening and configured to swing inward and outward; and
wherein the body is configured to fit within an opening in a door panel of the French door.

2. The panel insert of claim 1, wherein the body further comprises a transition element surrounding the perimeter for adjustably fitting the body within the opening in the door panel of the French door.

3. The panel insert of claim 1, wherein the pet door component further comprises a hinge for pivotally mounting the movable portion to the body.

4. The panel insert of claim 1, wherein the movable portion is a flap.

5. The panel insert of claim 1, wherein the pet door component further comprises a lower opening cover configured to block access through the lower opening.

6. A panel insert for a French door, the panel insert comprising:
a body comprising a perimeter, an upper opening, and a lower opening;
a window component configured to fit within the upper opening; and
a pet door component configured to fit within the lower opening; and
wherein the pet door component comprises a movable portion pivotally mounted within the lower opening and configured to swing inward and outward; and
wherein the body is configured to fit within an opening in a door panel of the French door.

7. The panel insert of claim 6, wherein the pet door component further comprises a lower opening cover configured to block access through the lower opening.

8. The panel insert of claim 6, wherein the window component is a glass panel integrated into the body within the upper opening.

9. The panel insert of claim 6, wherein the window component comprises a window configured to partially open.

10. The panel insert of claim 6, wherein the window component comprises a screen.

11. The panel insert of claim 6, wherein the window component comprises a locking element.

12. The panel insert of claim 6, wherein the window component comprises a window configured to partially open and an upper opening cover configured to block access through the upper opening.

13. The panel insert of claim 6, wherein the window component comprises a window configured to partially open and the movable portion of the pet door component is a flap.

14. The panel insert of claim 6, wherein the pet door component further comprises a locking element.

15. A pet accessible French door comprising:
a French door component comprising at least one door panel comprising a top rail, a bottom rail, a hinge style, and a lock style; and
a panel insert configured to fit within an opening defined by the top and bottom rails and the hinge and lock styles of the French door, the panel insert comprising:
a body comprising a perimeter, an upper opening, and a lower opening;
a window component configured to fit within the upper opening; and
a pet door component configured to fit within the lower opening; and
wherein the pet door component comprises a movable portion pivotally mounted within the lower opening and configured to swing inward and outward.

16. The pet accessible French door of claim 15, wherein the movable portion of the pet door component further comprises a top hinge for pivotally mounting the movable portion to the body.

17. The pet accessible French door of claim 15, wherein the movable portion of the pet door component further comprises a side hinge for pivotally mounting the movable portion to the body.

18. The pet accessible French door of claim 15, wherein the window component comprises a window configured to partially open and a locking element for securing the window.

19. The pet accessible French door of claim 15, wherein the pet door component further comprises a lower opening cover configured to block access through the lower opening.

20. The pet accessible French door of claim 15, wherein the window component comprises a window configured to partially open, a screen, and an upper opening cover configured to block access through the upper opening.
